(19) United States
(12) Patent Application Publication
(10) Pub. No.: US 2003/0092489 A1
(43) Pub. Date: May 15, 2003

(54) Interactive gaming with biometric verification

(76) Inventor: Annusorn Andy Veradej, Las Vegas, NV (US)

Correspondence Address: Michael J. Blankstein, WMS Gaming Inc., 800 South Northpoint Boulevard., Waukegan, IL, 60085, US

(21) Appl. No.: 10/045,200

(22) Filed: Nov. 9, 2001

(51) Int. Cl. A63F 13/00

(52) U.S. Cl. 463/36; 463/16

(57) ABSTRACT

A system and method for verifying an age of an interactive gaming player using a remote terminal to access a gaming site on a global computer network. The player initially registers with a registration facility associated with the gaming site. During the registration process, the registration facility receives proof from the player that the player satisfies a minimum age restriction. Also, the registration facility acquires a reference biometric attribute from the player. When the player later desires to use the remote terminal to access the gaming site and place wagers via the gaming site, the biometric attribute of the player is measured with a biometric measurement device at the remote terminal. The measured biometric attribute is compared with the reference biometric attribute previously acquired by the registration facility. If the measured biometric attribute sufficiently matches the reference biometric attribute, the gaming site accepts wagers placed by the player.

### FIELD OF THE INVENTION

The present invention relates generally to interactive gaming and, more particularly, to an interactive gaming system and method that measure a biometric attribute of a player to verify the player's age.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money and the intrinsic entertainment value of the machine relative to other available gaming options. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce different methods to attract frequent play by enhancing the entertainment value and excitement associated with the game.

Many game players want to be able to play gaming machines much more frequently then they are currently able to do. Such players are often limited because of the requisite travel required to attend casinos or other legal gaming establishments located in select portions of the United States. The involvedness, cost, and inconvenience of a player being forced to travel to a gaming establishment severely limits the amount of gambling excursions that a player can assume. Furthermore, since these excursions are infrequent, a gaming player is often forced to spend as much time gambling as possible during the excursion because such a player may not have the means to return to the gaming establishment for several months or years. There is continuing need for a gaming player to be able to gamble more frequently or for a shorter period time than is currently available and to be able to do so from a location remote to the gaming establishment.

Toward that end, interactive or “online” gaming allows a player to gamble from a location, such as a residence, remote to the gaming establishment. The player may access a gaming website on a global computer network (e.g., Internet) from a personal computer, personal digital assistant, wireless telephone, or other device coupled to the global computer network. To play a game available via the website, a player generally must supply credit or debit card account information. Wagers are deducted from the account, and payouts for winning outcomes are added to the account. Interactive gaming is one of the most rapidly expanding industries in the world, but it is largely unregulated. Thus far, minimum age restrictions are difficult if not impossible to administer on the global computer network, so this is a potential problem that particularly affects youth. A minimum age restriction would require an interactive gaming player to be at least a prescribed minimum age (e.g., 18 or 21 years old) in order to gamble legally. A need therefore exists for a system and method that facilitate administration of a minimum age restriction for interactive gaming.

### SUMMARY OF THE INVENTION

A system and method for verifying an age of an interactive gaming player using a remote terminal to access a gaming site on a global computer network. The player initially registers with a registration facility associated with the gaming site. During the registration process, the registration facility receives proof from the player that the player satisfies a minimum age restriction. Also, the registration facility acquires a reference biometric attribute from the player. When the player later desires to use the remote terminal to access the gaming site and place wagers via the gaming site, the biometric attribute of the player is measured with a biometric measurement device at the remote terminal. The measured biometric attribute is compared with the reference biometric attribute previously acquired by the registration facility. If the measured biometric attribute sufficiently matches the reference biometric attribute, the gaming site accepts wagers placed by the player.

### BRIEF DESCRIPTION OF THE DRAWINGS

The foregoing and other advantages of the invention will become apparent upon reading the following detailed description and upon reference to the drawings.

FIG. 1 is a block diagram of an interactive gaming system with biometric verification in accordance with the present invention.

FIG. 2 is a flow diagram of an interactive gaming method with biometric verification in accordance with the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

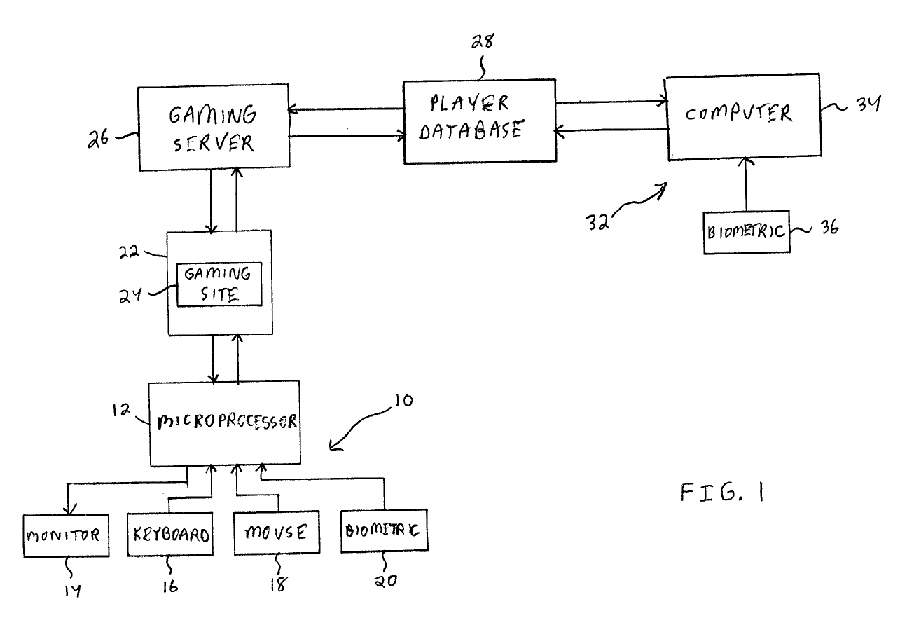

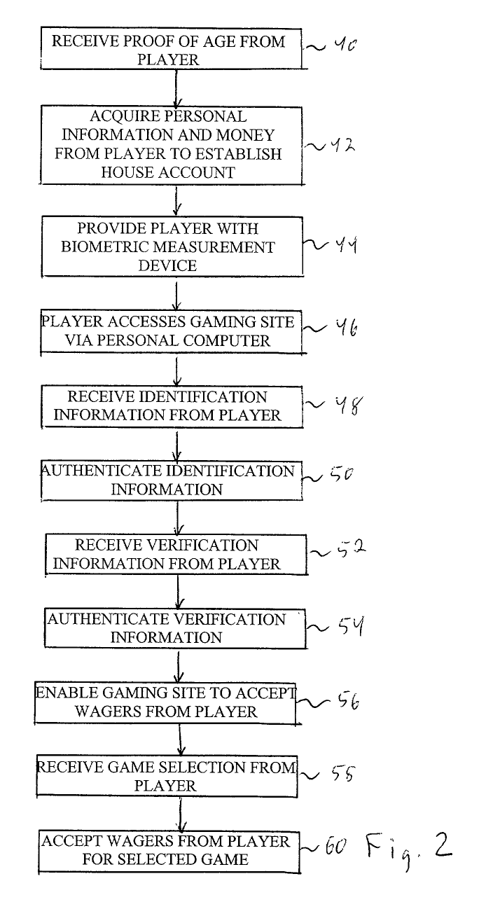

Turning now to the drawings, FIGS. 1 and 2 depict an interactive gaming system and method with biometric verification in accordance with the present invention. When an interactive gaming player wishes to use a remote terminal to access a gaming website on a global computer network (e.g., Internet) and place wagers via the gaming site, a biometric attribute of the player is measured with a biometric measurement device at the remote terminal. If the measured biometric attribute sufficiently matches a reference biometric attribute previously provided by the player to a registration facility along with proof of the player's age, the gaming site accepts wagers placed by the player. Thus, biometric verification of the player's age facilitates administration of a minimum age restriction for interactive gaming on the global computer network.

As noted above, interactive or “online” gaming (gambling) occurs on a global computer network. Starting in the 1990's, global computer networks such as the Internet became increasingly popular outlets. The Internet is a global communications network built on worldwide data and telephone networks. Computers connected to the Internet can exchange information with any other connected computer. The backbone of the Internet is founded on various sets of major telephone conduits and switches that exist across the world. These communications conduits are designed to move large volumes of data traffic at extremely high rates of speed.

Each of the major conduits referred to above terminates at a router, which is a large, fast switch that sorts the large volumes of data. Each router is connected to additional, local routing devices. Local routing devices, called “points of presence”, provide local Internet access. For example, an Internet termination router located in Chicago may have point-of-presence routers connected in, for example, Milwaukee and Indianapolis. A router is able to connect as many point-of-presence routers as the capacity of the switching systems and the Internet will permit.

In addition to point-of-presence routers, commercial Internet exchanges and global Internet exchanges also connect to the routers. These exchanges transfer data between Internet service providers, both nationally and internationally. When data originates on one U.S. Internet service provider with a destination on another U.S. long distance provider, the data is first routed to the commercial Internet exchange where it makes the transfer between providers.

Personal computers typically connect to a local point-of-presence router through a local Internet carrier. A local Internet carrier obtains a direct line to the point-of-presence router and provides a modem or other connection by which a personal computer user achieves Internet access. When the personal computer connects to the modem of the local Internet carrier, the local Internet carrier switches the home computer to the point-of-presence router, which in turn connects the personal computer to the Internet.

Another method of connecting computers to the Internet is by direct connection through a local area network (LAN) to the point of presence. Multiple personal computers can be connected to a single LAN, which connects to the point of presence through a leased data line. The computers connected to the LAN receive and transmit data to the point of presence through the LAN.

Attached to most LANs are a variety of different servers including the File Server and the Hypertext Transport Protocol (“HTTP”) server. The File Server connects to the LAN and contains the common data files used by the personal computers, the LAN and other servers. An HTTP server is a particular type of server that processes incoming and outgoing data written according to a certain Internet communication protocol, called hypertext transport protocol.

As described above, the Internet is able to interconnect every computer on the Internet with every other computer on the Internet. An Internet site typically includes certain data files (called “web pages” that are a part of the World Wide Web) in its File Server. The Internet site HTTP server makes those pages available to other computers on the Internet. An HTTP Server that makes World Wide Web pages available on the Internet usually includes a so-called “home page,” the starting point for outside users to navigate through the underlying World Wide Web pages serviced by the HTTP Server. These World Wide Web pages are written in a special World Wide Web language called Hypertext Markup Language (“HTML”). When a personal computer user wants to view a home page, it can do so by requesting that data over the Internet. In response, the requisite LAN retrieves the web page data from its File Server and instructs its HTTP Server to transmit the data, addressed via the Internet, to the personal computer that requested the information. The data generally travels from the local leased link to the point-of-presence router near the location of the LAN, through the Internet, through the point-of-presence router near the requesting personal computer, through the local Internet carrier, and into the modem of the requesting personal computer.

Transmission Control Protocol/Internet Protocol (“TCP/IP”) controls transmission of data on the Internet to provide World Wide Web communication to users. To insure that data is sent to and received by the appropriate receiver on the Internet, every device communicating on the Internet is assigned a unique address called an Internet Protocol (“IP”) address. Elements of the IP address identify the location in the network that a device is connected. Other parts of the IP address identify the specific device. The IP address number has a three-digit element that identifies the state of the resident and an additional seven digits, three of which identify the local exchange of the resident and four digits that specifically identify the home of the resident. The IP address is presently a thirty-two bit binary address, readily processed by computers, but cumbersome for use by human users. Consequently, the majority of IP addresses are assigned mnemonics to make them more “user friendly.” The mnemonic consists of two parts: a host name and a domain name. It is this representation of the IP address that is commonly used by Internet users to access Web sites. Conventionally within the World Wide Web, the mnemonic “WWW” is used to represent the host name. The remaining portion of the mnemonic represents the domain or network where the host resides. For example, www.uspto.gov, identifies a host named “www” in the domain (network) “uspto.gov”.

The standard protocol used by Internet components to address each other and usually is used as a Uniform Resource Locator (“URL”). This terminology appears as the opening element in the web site address. For example, http://www.uspto.gov, the Uniform Resource Locator indicates that the request is for “http” formatted data (i.e., a web page as opposed to, for example, an electronic mail message). The home page for the data resides on the “www” HTTP server on the “uspto.gov” LAN (or domain). The name of the file (to be found most likely in the file server supported by the uspto.gov LAN) is “homepage.html.”

Once a user has received an “HTML” formatted file corresponding to a web page, the text of the displayed file may prompt the user to request additional information contained in different web page files. The prompts are referred to as “hypertext” and usually show up on a home page (or other web page) in a different color than normal text, thus distinguishing them as hypertext links. Hypertext links (also called “hyperlinks”) in a document allow a reader to jump from one object to another object within the document and to objects outside of the document. Hyperlinks between documents create an informational space with no formal pathways. Hyperlinks may include any kind of hypertext or other hypermedia link connecting one HTML page to another HTML page in the currently displayed web site or in some external web site. HTML is the computer language used to “compose” and represent information on a web page. By clicking a mouse on the hypertext, the user is automatically “transported” from a current web page to a new web page linked to that hypertext.

For example, the master list server sends the request to a Domain Name Server (“DNS”) responsible for handling calls to this address. If the DNS recognizes the call, then an affirmation is sent to the master list server that directs the call to the server storing the particular home page. When the hypertext is selected, the browser requests a connection to the HTTP server hosting the file and it also requests from the HTTP server the file identified by the URL address. If the HTTP server accepts the connection requested by the browser, the HTTP server proceeds to transmit the requested file back to the browser. Once the browser receives the requested file, it delivers or presents the content of the file to the requesting user.

One of the most popular mediums for browsing the Internet is the World Wide Web. The World Wide Web is a client/server application that helps the user access various HTML pages available at various Internet sites. Its function is to display documents and to make links between items of information available. The user then chooses which links to follow as the user pursues a course through various World Wide Web pages. An Internet World Wide Web site refers to an entity connected to the Internet that supports World Wide Web communications and/or World Wide Web files. A typical web site will include an HTTP server and one or more HTML pages (sometimes referred to as World Wide Web pages).

A web site is usually configured to include a home page and a plurality of HTML pages that may each contain one or more hyperlinks. As a user clicks on one hyperlink in the home page, the user is transported to another HTML page. Further pages may have, for example, a hyperlink that returns the user to the home page or a hyperlink that forwards the user to a subsequent page.

An interactive gaming player can access a global computer network such as the Internet from a personal computer. It is contemplated in accordance with the present invention that other devices, such as a personal digital assistant, wireless telephone, or pager, can also be used to access the Internet. Therefore, although the discussion below refers, for simplicity, to a personal computer for accessing the Internet, it should be understood that such other devices may also be used.

FIG. 1 is a block diagram of an interactive gaming system with biometric verification in accordance with the present invention. In the system, a personal computer 10 preferably includes a microprocessor 12 and various peripherals linked to the microprocessor 12. The peripherals may, for example, include a video monitor 14, a keyboard 16, a mouse 18, and a biometric measurement device 20. The microprocessor 12 executes instructions from its read only memory (ROM) and, during such execution, the microprocessor 12 temporarily stores and accesses information from a random access memory (RAM). The video monitor 14 displays information that has been received by the personal computer 10, via the Internet 22, from a gaming website 24 controlled by a gaming server 26. The keyboard 16, the mouse 18, and the biometric measurement device 20 may be used by the player to transmit information to the gaming site 24 via the Internet 22. The transmitted information is available to the gaming server 26.

In response to being prompted by the gaming site 24, the player uses the biometric measurement device 20 to measure a biometric attribute of the player. The biometric attribute is selected from a group consisting of voice, iris, retina, fingerprint, handwriting, and face. Accordingly, the biometric measurement device 20 is selected from a group consisting of a voice data sensor, an iris scanner, a retina scanner, a fingerprint scanner, a handwriting recognizer, and a facial scanner. In a preferred embodiment, the biometric measurement device 20 is a fingerprint scanner of the type commercially available from Identix Incorporated of Los Gatos, Calif. The fingerprint scanner provides adjustable security thresholds so that it can be easily tuned to fit the exact security requirements of the desired application. The player inserts his or her finger into the fingerprint scanner which, in turn, electronically or optically captures a forensic-quality fingerprint image directly from the player's finger.

The gaming server 26 includes a microprocessor, a clock, and an operating system associated therewith. The microprocessor executes instructions from its read only memory (ROM) and, during such execution, the microprocessor temporarily stores and accesses information from a random access memory (RAM). The gaming server 26 is linked to the gaming site 24 and a player database 28. The gaming site 24 is a remote wagering network controlled by the gaming server 26. The gaming site 24 may, for example, be owned and operated by a gaming establishment such as a casino or by agencies or organizations separate from the gaming establishment. The player database 28 includes multiple records or “house accounts” each having multiple fields of information related to the identification of each player. The fields within each account may, for example, include an identification number, reference verification information (e.g., biometric attribute, pass code, etc.), name, date of birth, social security number, address, telephone number(s), credit card type, number and expiration date, monetary balance, and other requisite information.

Additional fields may include player tracking information and player preferences. The player tracking information may include an identification of last ten games played, specific information relating to the games played, and the jackpots and other prizes won by the player. For each denomination (e.g., nickel, dime, quarter, half-dollar, dollar, etc.), the game play data may include data fields for the number of credits played, the number of credits paid out, the number of games played, and the time of play in minutes. Of course, the amount and types of data stored in the player's account may be varied to suit a particular gaming site owner. Based on the player tracking information in the player's account, the gaming server 26 may compute bonuses and other rewards to be awarded to the player when playing a game via the gaming site 24 or at a gaming establishment affiliated with the gaming site owner.

The gaming server 26 posts a plurality of games on the gaming site 24. The plurality of games may, for example, be in such gaming categories as slots, poker, keno, bingo, blackjack, sportsbook, and horse racing. The gaming server 26 only permits qualifying players to place wagers on the games posted by the server 26 on the gaming site 24. To qualify, a player who accesses the gaming site 24 via the Internet 22 must satisfy certain restrictions, including minimum age restrictions. To determine whether the player satisfies any imposed restrictions, the gaming site 24 prompts the player to submit verification information via the personal computer 10. The verification information includes a biometric attribute and possibly a pass code. The gaming server 26 compares the submitted verification information to the reference verification information contained in the player's account in the player database 28. If the submitted verification information sufficiently matches the reference verification information, the gaming server 26 accepts wagers placed by the player via the gaming site 24.

To establish a house account in the player database 28, the player preferably must go to a registration facility. The registration facility may include an attendant station 32 operated by an attendant. The attendant station 32 may include a personal computer 34 and a biometric measurement device 36 of the same type as the biometric measurement device 20 to be used by the player at his or her personal computer 10. In fact, during the registration process at the registration facility, the registration facility may provide the player with the biometric measurement device 20. Depending upon the financial model employed by the owner of the gaming site 24, the biometric measurement device 20 may be free or purchased by the player for a fee.

The attendant station 32 may be connected directly to the player database 28 as shown or may be connected to the player database 28 via the gaming server 26. If the attendant station 32 is connected to the player database 28 via the gaming server 26, the attendant station 32 may be connected to the gaming server 26 via the Internet 22. Prior to establishing an account for a prospective player in the player database 28, the player must provide an attendant at the attendant station 32 with proof that the player satisfies the minimum age restriction (e.g., 18 or 21 years old) for interactive gaming. The proof may, for example, include one or more forms of identification such as a driver's license or a passport. Upon receipt of sufficient proof of age, the attendant acquires sufficient personal information from the player to establish an account for that player in the player database 28. Among the acquired information is reference verification information including a pass code and a reference biometric attribute measured with the biometric measurement device 36.

FIG. 2 is a flow diagram of an interactive gaming method with biometric verification in accordance with the present invention. The method utilizes the components of the interactive gaming system in FIG. 1 and therefore reference is made to these components in the method description below.

First, an attendant at the registration facility receives proof from a prospective player that the player satisfies the minimum age restriction for interactive gaming (step 40). As noted above, the proof may include one or more forms of identification such as a driver's license or a passport.

Second, upon receipt of the proof of age, the attendant acquires personal information and possibly money from the player to establish a record or “house account” in the player database 28 (step 42). The account may be assigned an identification number. As noted above, the personal information may include reference verification information (e.g., biometric attribute, pass code, etc.), name, date of birth, social security number, address, telephone number(s), monetary balance, and other requisite information. The reference biometric attribute is an important piece of information to acquire from the player. The biometric measurement device 36 measures the reference biometric attribute under the supervision of the attendant. In addition to the reference biometric attribute, the attendant may acquire other reference verification information such as a pass code selected by either the attendant or the player. The attendant may provide the player with an identification card including the player's name, the identification number, and the pass code.

The gaming site 24 may be set up to accept wagers from one or more monetary sources. One monetary source may be a credit card, in which case the attendant may acquire credit card information (e.g., credit card type, number, and expiration date) from the player. Another monetary source may be money stored with the player's account, in which case the player must provide the attendant with money to deposit into the player's account, or arrange for a line of credit in the player's account.

Third, the attendant provides the player with a biometric measurement device 20 to link to the player's personal computer (step 44). As noted above, depending upon the financial model employed by the owner of the gaming site 24, the biometric measurement device 20 may be free or purchased by the player for a fee. The biometric measurement device 20 is of the same type as the biometric measurement device 36 at the attendant station 32. The player is now ready to engage in interactive gaming from the player's personal computer 10.

Fourth, the player uses the personal computer 10 to access the gaming site 24 on the Internet 22 (step 46). To access the gaming site 24, the player enters the host name and the domain name for the gaming site 24 in the address field of the web browser used by the player to navigate the Internet. If the player does not know the host name and the domain name, the player may employ a search engine to search for the gaming site based on a search query entered by the player.

The home page of the gaming site 24 may offer numerous gaming options to the player and present such options with hyperlinks. The gaming options may, for example, include a help option, a free play option, and a wager-to-play option. The help option may explain how to use the gaming site 24, how to register to wager on games available on the gaming site 24, and how to play the games available on the gaming site 24. The free play option may allow players (whether or not they are registered) to play the games for fun. The free play option affords players the opportunity to learn how to play the games available on the gaming site 24. Players do not place wagers and are not awarded money for winning game outcomes. The wager-to-play option allows players who have previously registered at the registration facility to place wagers on the games available on the gaming site 24 upon submission of verification information that sufficiently matches the reference verification information submitted to the registration facility. The reference verification information is stored in the player database 28.

Fifth, if the player selects the wager-to-play option, the gaming site 24 prompts the player to provide identification information such as the player's name and/or identification number (step 48). The identification number may be included on the identification card provided to the player by the registration facility.

Sixth, in response, the gaming server 26 authenticates the identification information by attempting to access the player's account in the player database 28 (step 50). If the gaming server 26 cannot locate an account for the player, the gaming site 24 so informs the player and may further inform the player as to how the player can register at a registration facility to establish an account. If the gaming server 26 is able to locate an account for the player, the gaming site 24 prompts the player to submit fresh verification information. The fresh verification information should be the same as the reference verification information provided by the player to the registration facility and stored with the player's account in the player database 28.

Seventh, the player submits the requested verification information to the gaming site 24 (step 52). As noted above, the verification information may, for example, include a biometric attribute and a pass code. The biometric attribute is measured with the biometric measurement device 20 provided to the player by the registration facility. The biometric measurement device 20 is linked to the microprocessor 12 of the player's personal computer 10. Upon measuring the biometric attribute, the microprocessor 12 transmits the measured biometric attribute to the gaming site 24 which, in turn, transmits the biometric attribute to the gaming server 26. The pass code may be included on the identification card. The gaming site 24 preferably includes a secure page on which the player can enter the pass code via the keyboard 16. The gaming site 24 transmits the entered pass code to the gaming server 26.

Eighth, the gaming server 26 authenticates the submitted verification information by comparing it to the reference verification information stored with the player's account in the player database 28 (step 54). This includes (1) a comparison of the entered pass code with the reference pass code and (2) a comparison of the measured biometric attribute with the reference biometric attribute. On the one hand, if the submitted verification information does not sufficiently match the reference verification information, the gaming site 24 so informs the player and may either prompt the player to try again and/or inform the player as to how the player can register at a registration facility to establish an account.

On the other hand, if the submitted verification information sufficiently matches the reference verification information, the gaming server 26 enables the gaming site 24 to accept wagers placed by the player for playing games available under the wager-to-play option of the gaming site 24 (step 56). In one embodiment, the entered pass code must exactly match the reference pass code in terms of both the sequence of individual characters and the case (i.e., uppercase or lowercase) of the characters. In another embodiment, the case of the characters is not considered. The measured biometric attribute must match the reference biometric attribute to a predetermined threshold established by the owner of the gaming site 24.

Ninth, the gaming server 26 receives the player's selection of a game to play (step 58). The player makes his or her selection via the gaming site 24. The gaming site 24 may identify numerous gaming categories under the wager-to-play option and present such categories with hyperlinks. The categories may, for example, include slots, poker, keno, bingo, blackjack, sportsbook, and horse racing. Under each category, the gaming site 24 may identify specific games available for play and may allow a qualifying player (i.e., a player that submitted correct verification information) to commence play of such games with respective hyperlinks. The slots category may, for example, include a library of slot games in which each slot game includes its own art, sound, math, and special game play features.

Tenth, the gaming server 26 accepts wagers placed by a qualifying player via the gaming site 24 for a selected game (step 60). As noted above, the wagers may be placed with money obtained from a monetary source such as a credit card or the player's house account. If the gaming site 24 permits the use of credit cards, the gaming site 24 may prompt the player to confirm the credit card information stored with the player's account in the player database 28. Also, the gaming site may allow the player to update the credit card information via the gaming site 24 if such information has changed. Regardless of the monetary source for wagers, the gaming server 26 deducts wagers from the monetary source and adds payoffs for winning game outcomes to the monetary source. If the monetary source is money in the player's house account, the gaming server 26 allows the player to continue wagering on games until the monetary balance reaches a predetermined minimum balance such as zero. If the monetary source is a credit card, the gaming server 26 allows the player to continue wagering on games until the credit card balance reaches a predetermined amount such as the player's credit limit. If the player has insufficient funds to continue playing, the gaming site 24 displays a message indicating a lack of funds. In response, the player must discontinue wagering via the gaming site 24 until replenishing or changing the monetary source.

In the above-described interactive gaming method, the player must submit his or her biometric attribute for verification of the player's identity prior to initiating play of a game under the wager-to-play option of the gaming site 24. The interactive gaming method may additionally require the player to submit his or her biometric attribute at random times during play of the game and/or prior to granting any awards to the player for winning game outcomes. Furthermore, the personal computer 10 may be outfitted with more than one type of biometric measurement device 20 for redundant verification of the player's identity. In addition to a biometric measurement device 20, the personal computer 10 may be outfitted with a camera (e.g., web cam) that monitors, or takes pictures of, the player using the personal computer 10. The gaming site operator compares the monitored player to a reference picture of the player acquired when the player registers for interactive gaming at the registration facility.

While the present invention has been described with reference to one or more particular embodiments, those skilled in the art will recognize that many changes may be made thereto without departing from the spirit and scope of the present invention.

For example, instead of storing the reference verification information with the player's account in the player database 28, the reference verification information may be stored on the portable identification card provided to the player by the registration facility. The identification card in this case is preferably a smart card capable of securely storing the verification information and preventing unauthorized access thereto. The biometric measurement device 20 preferably is accompanied by, or has incorporated therein, a smart card reader. When verifying the identity of a player who wishes to engage in interactive gaming via the gaming site 24, the player is prompted to insert the smart card into the smart card reader and also submit fresh verification information for comparison with the reference verification information on the smart card. The fresh verification information and the reference verification information on the smart card are transmitted by the player's personal computer to the gaming server 26, which performs the comparison.

Each of these embodiments and obvious variations thereof is contemplated as falling within the spirit and scope of the claimed invention, which is set forth in the following claims:

What is claimed is:

1. A method for verifying an age of an interactive gaming player using a remote terminal to access a gaming site on a global computer network, the method comprising:
receiving proof from the player that the player satisfies a minimum age restriction;
acquiring reference verification information from the player, the reference verification information including a reference biometric attribute;
receiving verification information from the player at the remote terminal, the receiving step including measuring a biometric attribute of the player with a biometric measurement device at the remote terminal;
comparing the received verification information with the reference verification information; and
accepting wagers placed by the player via the gaming site if the received verification information sufficiently matches the reference verification information.

2. The method of claim 1, wherein the reference biometric attribute is selected from a group consisting of voice, iris, retina, fingerprint, handwriting, and face.

3. The method of claim 1, wherein the step of acquiring reference verification information includes storing the reference verification information in a storage unit.

4. The method of claim 3, wherein the storage unit is portable and possessed by the player.

5. The method of claim 4, wherein the storage unit is contained on a card.

6. The method of claim 3, wherein the storage unit is possessed by an entity associated with the gaming site.

7. The method of claim 1, wherein the reference verification information includes a pass code.

8. The method of claim 1, wherein the biometric measurement device is selected from a group consisting of a voice data sensor, an iris scanner, a retina scanner, a fingerprint scanner, a handwriting recognizer, and a facial scanner.

9. The method of claim 1, wherein the steps of receiving proof from the player and acquiring reference verification information from the player occur at a registration facility associated with the gaming site.

10. A system for verifying an age of an interactive gaming player using a remote terminal to access a gaming site on a global computer network, the method comprising:
means for receiving proof from the player that the player satisfies a minimum age restriction;
means for acquiring reference verification information from the player, the reference verification information including a reference biometric attribute;
means, at the remote terminal, for receiving verification information from the player at the remote terminal, the received verification information including a biometric attribute;
means for comparing the received verification information with the reference verification information; and
means for accepting wagers placed by the player via the gaming site if the received verification information sufficiently matches the reference verification information.

11. The system of claim 10, wherein the reference biometric attribute is selected from a group consisting of voice, iris, retina, fingerprint, handwriting, and face.

12. The system of claim 10, wherein the means for acquiring reference verification information includes a biometric measurement device for reading the reference biometric attribute and a storage unit for storing the reference verification information.

13. The system of claim 12, wherein the storage unit is portable and possessed by the player.

14. The system of claim 13, wherein the storage unit is contained on a card.

15. The system of claim 12, wherein the storage unit is possessed by an entity associated with the gaming site.

16. The system of claim 10, wherein the reference verification information includes a pass code.

17. The system of claim 10, wherein the means for receiving verification information includes a biometric measurement device selected from a group consisting of a voice data sensor, an iris scanner, a retina scanner, a fingerprint scanner, a handwriting recognizer, and a facial scanner.

18. The system of claim 10, wherein the means for receiving proof and the acquiring means are located at a registration facility associated with the gaming site.
